(19) United States
(12) Patent Application Publication
(10) Pub. No.: US 2011/0145906 A1
(43) Pub. Date: Jun. 16, 2011

(54) INFORMATION PROCESSING APPARATUS CAPABLE OF OPERATING IN ADMINISTRATOR MODE, CONTROL METHOD THEREOF AND RECORDING MEDIUM

(75) Inventors: Akemi MORITA, Nishinomiya-shi (JP); Takashi Ueda, Kashiba-shi (JP); Keita Minami, Amagasaki-shi (JP)

(73) Assignee: Konica Minolta Business Technologies, Inc., Tokyo (JP)

(21) Appl. No.: 12/969,265

(22) Filed: Dec. 15, 2010

(30) Foreign Application Priority Data
Dec. 16, 2009 (JP) 2009-285140(P)

(51) Int. Cl. H04L 9/32; G06F 21/00

(52) U.S. Cl. 726/7; 726/19

(57) ABSTRACT

An information processing apparatus includes an executing unit executing information processing, a control unit controlling an operation of the executing unit, a storage unit for storing specific information for executing an administrator mode and a communication unit for communicating with a smart card. When information matching the PIN code stored in the smart card and information matching the information stored in said storage unit are received, the control unit executes the administrator mode.

This application is based on Japanese Patent Application No. 2009-285140 filed with the Japan Patent Office on Dec. 16, 2009, the entire content of which is hereby incorporated by reference.

### BACKGROUND OF THE INVENTION

1. Field of the Invention

The present invention relates to an information processing apparatus, an information processing method and an information processing program and, more specifically, to an information processing apparatus that can operate in an administrator mode.

2. Description of the Related Art

Conventionally, it has been possible in an information processing apparatus to allow different users to use different functions. By way of example, Japanese Laid-Open Patent Publication No. 07-044499 discloses a technique in which only the menu designated by a piece of information read from a portable recording medium such as an IC (Integrated Circuit) card is displayed on an operation image of an information processing apparatus.

Some of the conventional information processing apparatuses are configured to allow operation in a mode for utilizing general functions and in an administrator mode for receiving information input to enable settings related to various functions.

In such an information processing apparatus, it is often the case that a log-in process necessary for utilizing general functions and a log-in process for an administrator to enable settings related to execution of various functions are managed separately. For instance, in the log-in process for utilizing general functions, a piece of information input by a user (for example, user name and password) is transmitted to an authentication server, and user authentication takes place. If user authentication succeeds, the user is permitted to log-in and to use general functions of the information processing apparatus. On the other hand, in the log-in process for an administrator, determination is made as to whether the piece of information input by a user matches log-in information for an administrator stored in the information processing apparatus, and whereby authentication is conducted. If the authentication succeeds, the user can operate the information processing apparatus in the administrator mode for receiving information input to set functions.

In the conventional information processing apparatus, however, if the log-in information for an administrator stored in the information processing apparatus should be stolen and leaked unintentionally to a third party, the unauthorized third party could be permitted to log-in as an administrator. Accordingly, improved security regarding log-in to the administrator mode has been desired.

### SUMMARY OF THE INVENTION

The present invention was made in view of the foregoing and its object is to improve security level of log-in to the administrator mode in an information processing apparatus.

According to an aspect, the present invention provides an information processing apparatus, including: an executing unit executing information processing; a control unit controlling an operation of the executing unit; a communication unit for communicating with a smart card; an receiving unit for receiving input of information; and a storage unit for storing specific information for executing an administrator mode; wherein the control unit executes the administrator mode if information matching the PIN (personal identification number) code stored in the smart card and information matching the information stored in the storage unit are received by the receiving unit.

According to another aspect, the present invention provides a method of controlling an information processing apparatus including a storage unit, an executing unit executing information processing and a control unit controlling an operation of the executing unit, comprising the steps of: communicating with a smart card; receiving input of a PIN code; determining whether or not the input PIN code matches the PIN code stored in the smart card; storing specific information in the storage unit for executing an administrator mode; receiving input of information corresponding to the specific information; determining whether or not the input information corresponding to the specific information matches the specific information stored in the storage unit; and causing the control unit to execute the administrator mode, if it is determined that the input PIN code matches the PIN code stored in the smart card and that the input information matches the specific information stored in the storage unit.

According to a further aspect, the present invention provides a non-transitory recording medium recording a computer readable program for controlling a storage unit, an information processing apparatus including an executing unit executing information processing and a control unit controlling an operation of the executing unit, causing the information processing apparatus to execute the steps of: communicating with a smart card; receiving input of a PIN code; determining whether or not the input PIN code matches the PIN code stored in the smart card; storing specific information in the storage unit for executing an administrator mode; receiving input of information corresponding to the specific information; determining whether or not the input information corresponding to the specific information matches the specific information stored in the storage unit; and causing the control unit to execute the administrator mode, if it is determined that the input PIN code matches the PIN code stored in the smart card and that the input information matches the specific information stored in the storage unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows an exemplary configuration of an information processing system including an MFP (Multi Function Peripheral) in accordance with a first embodiment of the information processing apparatus of the present invention.

FIG. 2 is a control block diagram of the MFP shown in FIG. 1.

FIG. 3 is a schematic illustration showing contents of operations when a user logs in as an administrator to the MFP shown in FIG. 2.

FIG. 4 shows an exemplary image displayed on an operation panel when the MFP shown in FIG. 2 operates in the administrator mode.

FIG. 5 is a flowchart representing a log-in process executed by the MFP of FIG. 2.

FIG. 6 is a flowchart representing a log-in process executed by an MFP in accordance with a second embodiment of the information processing apparatus of the present invention.

FIG. 7 is a flowchart representing a log-in process executed by an MFP in accordance with a third embodiment of the information processing apparatus of the present invention.

FIG. 8 is a flowchart representing a log-in process executed by an MFP in accordance with a fourth embodiment of the information processing apparatus of the present invention.

### DESCRIPTION OF THE PREFERRED EMBODIMENTS

### First Embodiment

(Overall System Configuration)

FIG. 1 schematically shows an overall configuration of an information processing system using an MFP (Multi Function Peripheral) as a first embodiment of the information processing apparatus in accordance with the present invention.

Referring to FIG. 1, the information processing system includes an MFP 100, an authentication server 200, a mail server 300 and a personal computer (PC) 500. These apparatuses are connected to a network, and the network is connected to a public communication network such as the Internet, through a gateway, not shown.

PC 500 represents an information processing terminal used by an individual user.

Authentication server 200 is a server referred to by MFP 100 for user information, when it receives a log-in request to MFP 100 from, for example, PC500.

Mail server 300 is a server that executes the transmission/reception operations of electronic mails transmitted to/received from MFP 100, with an external network. MFP 100 transmits/receives electronic mails through mail server 300.

(MFP Configuration)

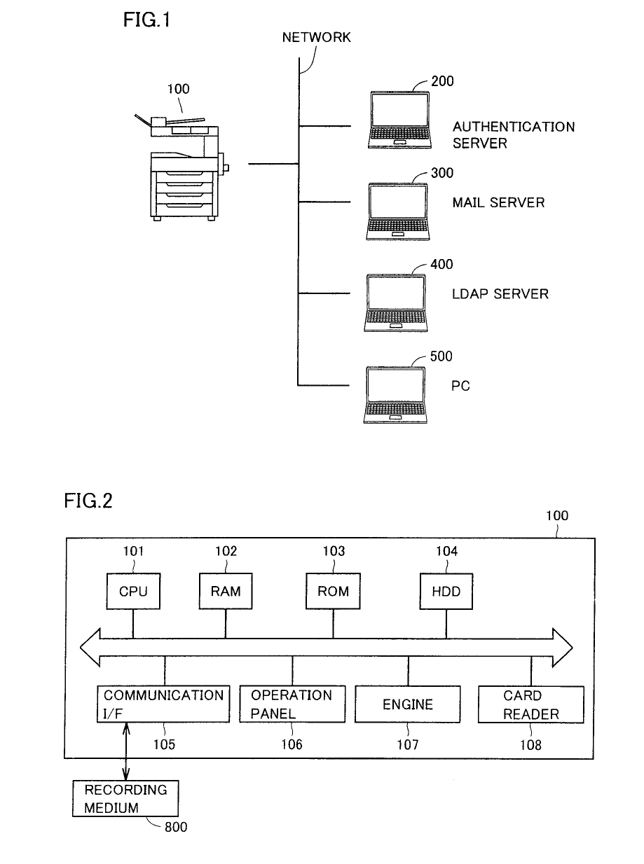

FIG. 2 shows a control block diagram of MFP 100 of FIG. 1.

Referring to FIG. 2, MFP 100 includes: a CPU (Central Processing Unit) 101 for overall control of the apparatus; an RAM (Random Access Memory) 102 for temporarily storing data; an ROM (Read Only Memory) 103 for storing programs, constants and the like; a hard disk drive (HDD) 104 for storing image data and the like; a communication interface (I/F) 105 for connection to the network formed by the information processing system shown in FIG. 1; an operation panel 106 receiving an operation for input by a user; an engine 107 executing an image forming operation, image reading operation and the like; a card reader 108; and a media drive 109. Engine 107 includes, for example, a printer for performing the image forming operation and a scanner for performing the image reading operation.

Card reader 108 reads and writes data to be recorded on a recording medium as a smart card that can be inserted to card reader 108. The recording medium card here corresponds to a PM (Public Key Infrastructure) card 900, which will be described later. Generally, an IC chip is embedded in a smart card, and information can be recorded in the IC chip.

CPU 101 reads and writes information from and to a recording medium 800 that can be detachably attached to MFP 100, through media drive 109.

In the information processing system in accordance with the present embodiment, each user has a PM card storing his/her electronic certificate and the like. In the system, user authentication is done based on the information recorded on the PM card. The information stored in PKI card 900 includes a PIN (Personal Identification Number) code, a pair of private and public keys, electronic certificate, user name (hereinafter appropriately referred to as “ID” or “user ID”) and a password, of the user as a legitimate holder. The PIN code is a secret identification number for identifying the card holder.

In MFP 100, CPU 101 executes a prescribed program to perform processes for the image forming operation, such as formation of image data using the scanner of engine 107 and image output using the printer of engine 107. The program executed by CPU 101 is stored in ROM 103 or HDD 104, or read by CPU 101 from an external storage (including recording medium 800 detachably attached to MFP 100) through communication I/F 105.

CPU 101 executes the process described in the present specification by executing the program described above.

CPU 101 realizes operations of MFP 100 in a plurality of modes. The plurality of modes include an image processing mode and an administrator mode. The image processing mode is to cause MFP 100 to execute image processing operations such as printing and scanning. The administrator mode is for setting how and/or which type of image forming operation is to be executed by MFP 100 in the image processing mode. The image processing mode includes a public mode and a normal mode. The public mode allows general users widely to use some functions (such as mono-color printing) of MFP 100 without requiring log-in of the user as an operator. The normal mode allows a logged-in user to execute, by MFP 100, an image forming operation corresponding to the user.

(Operation of MFP in Administrator Mode)

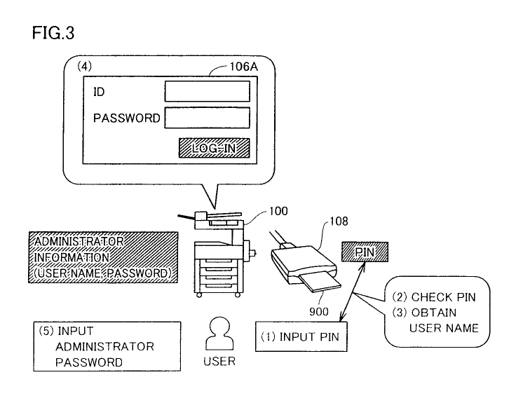

FIG. 3 illustrates contents of operation of MFP 100, when the user logs-in to MFP 100 as an administrator and causes MFP 100 to operate in the administrator mode, in accordance with the present embodiment.

Referring to FIG. 3, when the user inserts PKI card 900 to card reader 108 of MFP 100, CPU 101 displays an image requesting input of PIN code on operation panel 106.

If the user inputs the PIN code in response, CPU 101 checks the input PIN code with the PIN code stored in PM card 900 and, if these codes are determined to match, it obtains the user name from PM card 900.

If the obtained user name is a user name registered as an administrator in MFP 100, CPU 101 displays a log-in image shown as image 106A in FIG. 3, on operation panel 106. The log-in image is an image requesting the user to input user ID and password.

The process of obtaining user name in PM card 900 when PM card 900 is inserted to card reader 108 may be omitted. Specifically, CPU 101 may display the log-in image, no matter whether or not the user name in the inserted PM card 900 is stored as the user name of an administrator in MFP 100.

If the user inputs the user ID and password for the administrator to image 106A in accordance with the display on the log-in image, CPU 101 checks the input information with administrator information stored in HDD 104 or the like. If the pieces of information are determined to match, it causes MFP 100 to operate in the administrator mode. In HDD 104 of MFP 100, information (for example, user name and password) of the user registered as an administrator is stored as administrator information. The check mentioned above is done by comparing the input information and the information stored as described above.

Table 1 shows exemplary contents processed in the administrator mode of MFP 100. As shown in the column of large classification, the contents of processing are roughly divided to two types, that is, “User Registration” and “Operation Setting”.

TABLE 1

| Large Classification | Middle Classification | Small Classification |
|---|---|---|
| User Registration | Edit | New user registration |
| | | Function restriction |
| | Verify | List of registered users |
| | | Restricted contents of each user |

| | |
|---|---|
| Operation Setting | Operation mode setting |
| | Operation contents setting |

“User Registration” is a menu for registering or verifying individual information of each user.

“Operation Setting” is a menu for setting operation contents of MFP 100 itself.

As shown in the column of middle classification of Table 1, “User Registration” includes “Edit” and “Verify” menus. “Edit” is a menu for newly registering information of each user or updating already registered information, and “Verify” is a menu for verifying the registered contents of each user.

As shown in the column of small classification of Table 1, “Edit” includes “New user registration” and “Function restriction” menus.

“New user registration” is a menu for registering information of a user who is not yet registered as a user of MFP 100. “Function restriction” is a menu for setting operation contents of MEP 100 of which execution is permitted for each user already registered with MFP 100.

As shown in the column of small classification of Table 1, “Verify” includes “List of registered users” and “Restricted contents of each user” menus. “List of registered users” is a menu for displaying a list of registered users of MFP 100. “Restricted contents of each user” is a menu for displaying contents of restriction of operations set by “Function Restriction” menu.

“Operation Setting” is a menu for setting operation conditions related to operations common to each user of MFP 100, and it includes “Operation mode setting” and “Operation contents setting” menus.

“Operation mode setting” is a menu for setting overall operation mode of MFP 100. The operation mode includes the public mode.

“Operation contents setting” is a menu for setting contents of each operation. The contents of each operation includes, for example, an IP (Internet Protocol) address of a server communicated as authentication server 200.

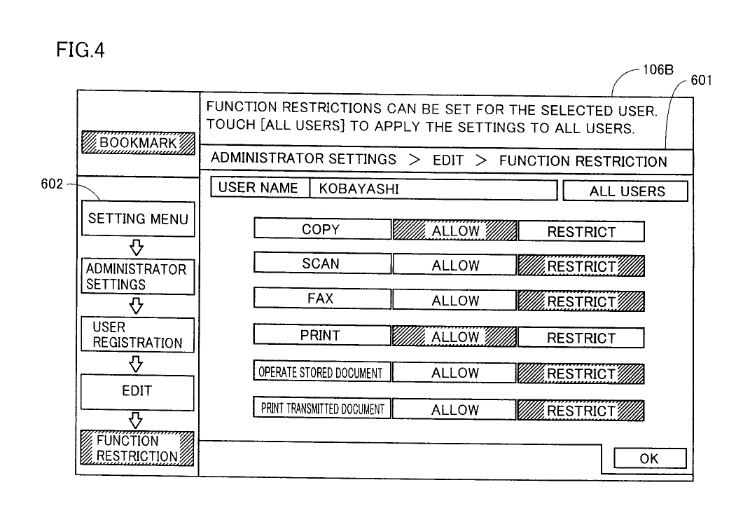

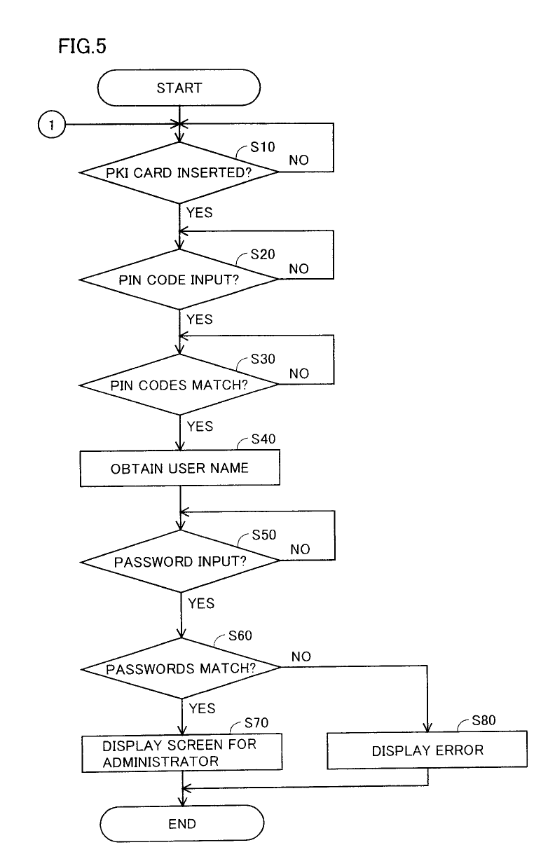

FIG. 4 shows an exemplary image displayed on operation panel 106 when “Function Restriction” menu described above is being executed in MFP 100.

Referring to FIG. 4, an image 106B includes a display area 601 for displaying contents of restriction, and a display area 602 for displaying a menu.

In display area 601, the user name and contents of settings to allow/restrict the user to perform each of the operations (copy, scan, facsimile, print, operation of stored document and printing of transmitted document) are displayed. The user name on display area 601 represents the name of a user as an object of setting the operation contents, who is already registered with MFP 100.

The administrator can set whether each operation is allowed or restricted for the user, by operating “Allow” button or “Restrict” button related to each of the operation contents. In accordance with the contents of operation by the administrator, contents displayed on operation area 601 are updated. When OK button on display area 601 is operated, the restricted contents displayed on image 106B are fixed and stored in MFP 100.

Each user can cause MFP 100 to execute only the operations (information processing) allowed in accordance with the setting as described above.

Display area 602 shows menu items that have been selected by the administrator in order to have such a setting image as shown as image 106B displayed. In display area 602, menu items are displayed in the order of selection. By the display on display area 602, it is possible to readily confirm the contents of operations made by the user logged-in as the administrator, until the image 106B is displayed.

(Log-in Process in MFP)

FIG. 5 is a flowchart representing a process (log-in process) executed by CPU 101 when the user logs in to MFP 100 as the administrator.

Referring to FIG. 5, in the log-in process, at step S10, CPU 101 first determines whether or not PKI card 900 is inserted to card reader 108. If it is determined to be inserted, an image for inputting PIN code is displayed on operation panel 106, and the process proceeds to step S20.

At step S20, CPU 101 determines whether or not a PIN code is input by the user, and if it is determined that the input is done, the process proceeds to step S30.

At step S30, whether or not the PIN code input at step S20 matches the PIN code stored in the PKI card inserted to card reader 108 at step S10 is determined, and if matching is determined, the process proceeds to step S40.

The determination as to whether the PIN codes match at step S30 may be done by CPU 101 reading PIN code from PKI card 900 for comparing. Alternatively, the PIN code received at step S20 may be transmitted to PKI card 900, a command instructing checking of PIN code may be transmitted to PKI card 900, and determination may be made based on the contents of information (whether the PIN codes matched or not) transmitted, as a response to the command, from PKI card 900.

At step S40, CPU 101 obtains the user name of PKI card 900 from PM card 900, and displays an image (log-in image) requesting input of user name and password on operation panel 106, and the process proceeds to step S50.

At step S50, CPU 101 determines whether or not the password is input to the log-in image displayed at step S40, and if it is determined that input is done, the process proceeds to step S60.

At step S60, CPU 101 determines whether or not the password input at step S50 matches the password stored in HDD 104 or the like in association with the user name obtained at step S40, and if it is determined that the passwords match, the process proceeds to step S70.

On the contrary, if it is determined that the passwords do not match, an error indication is given at step S80, and the log-in process ends.

At step S70, CPU 101 permits the user who is operating at present to log-in to MFP 100 as an administrator and displays a screen for an administrator on operation panel 106, and thus, the log-in process ends.

After the screen is displayed at step S70, the user appropriately operates operation panel 106, whereby he/she can operate MFP 100 in the administrator mode.

### Effects of the Present Embodiment

In the embodiment of the present invention described above, CPU 101 constitutes executing means for executing information processing such as transmission of image data an image output by MFP 100. CPU 101 appropriately drives engine 107 for information processing.

Card reader 108 constitutes communication means for communicating with a smart card (PM card 900).

Further, CPU 101 executing the process for displaying an image requesting input of PIN code and receiving the PIN code input from the user (step S20) when PM card 900 is inserted to card reader 108 constitutes first receiving means.

CPU 101 checking the input information with the PIN code in PM card 900 and determining whether they match constitutes first determining means.

Further, HDD 104 storing the user ID and password of the user registered as an administrator constitutes storage means.

CPU 101 displaying an image (log-in image) requesting input of user ID and password on operation panel 106 constitutes second receiving means.

Further, CPU 101 checking the user ID and password input by the user in response to the display of log-in image with the user ID and password stored in HDD 104 and determining whether they match constitutes second determining means.

In MFP 100, if the input PIN code matches the PIN code stored in PM card 900 and the input user ID and password match the user ID and password stored in HDD 104, CPU 101 operates MFP 100 in the administrator mode.

In MFP 100 in accordance with the present embodiment, if log-in of a user utilizing general functions requires authentication by authentication server 200 and MFP 100 fails to communicate with authentication server 200, it possible to operate MFP 100 at least in the administrator mode. Therefore, if MFP 100 is set to operate in the public mode as mentioned above, minimum functions of MFP 100 can be provided to the user without necessitating log-in, even if communication with authentication server 200 is impossible.

Further, log-in permission as an administrator requires checking of the user ID and password for the administrator as well as checking of PIN code of PKI card for the administrator. Therefore, security level at log-in as an administrator can be improved.

### Second Embodiment

MFP 100 as a second embodiment of the information processing apparatus in accordance with the present invention may have hardware configuration similar to that of MFP 100 of the first embodiment.

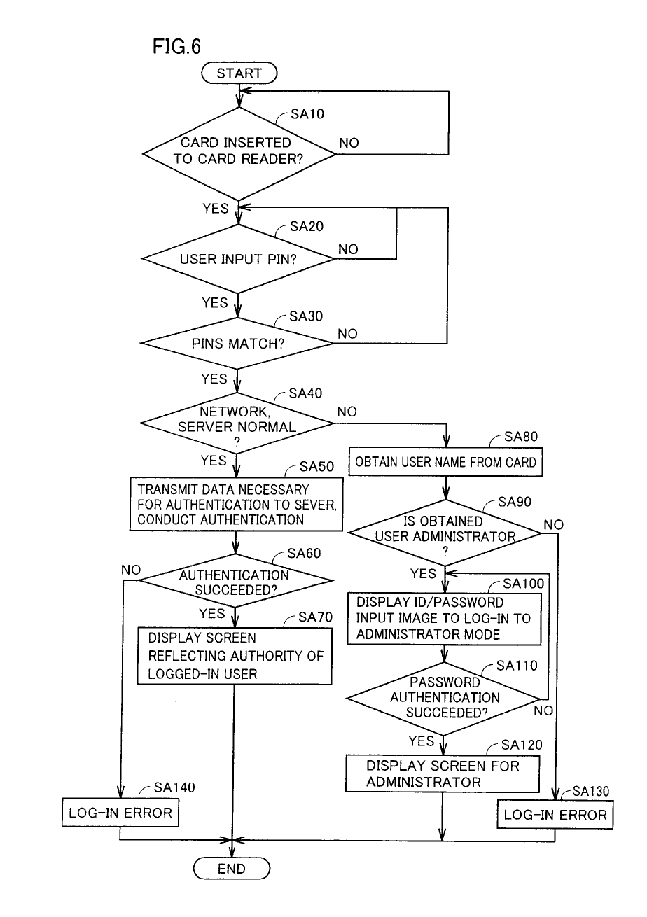

FIG. 6 is a flowchart representing a log-in process executed by CPU 101 of MFP 100 in accordance with the present embodiment.

Referring to FIG. 6, in the log-in process of the present embodiment, at step SA10, CPU 101 first determines whether or not a PKI card is inserted to card reader 108. If it is determined to be inserted, an image requesting input of PIN code is displayed on operation panel 106, and the process proceeds to step SA20.

At step SA20, CPU 101 determines whether or not a PIN code is input to the image displayed at step SA10, and if it is determined that the input is done, the process proceeds to step SA30.

At step SA30, as at step S30 (see FIG. 5), CPU 101 determines whether or not the PIN code determined to be input at step SA20 matches the PIN code stored in PKI card 900, and if matching is determined, the process proceeds to step SA40.

At step SA40, CPU 101 determines whether or not communication on the network shown in FIG. 1 is normal and communication with authentication server 200 is normal. If communications are determined to be normal, the process proceeds to step SA50, and if communications are determined to be impossible, the process proceeds to step SA80.

Here, by way of example, CPU 101 transmits a piece of information for starting communication to authentication server 200, and if an appropriate data is returned, it determines that normal communication on the network and normal communication with authentication server 200 are possible. If such data is not received, it determines that communication with authentication server 200 is impossible.

Steps SA50 to SA70 are the process to allow a user to log-in not as an administrator but as a user (authorized user) who operates MFP 100 to execute information processing.

At step SA50, CPU 101 obtains data necessary for user authentication by, for example, reading from PM card 900. Then, it transmits the data to authentication server 200 and requests authentication server 200 to authorize the user. Then, the process proceeds to step SA60.

At step SA60, whether or not user authentication requested at step SA50 has been successful is determined, and if it is determined to be successful, the process proceeds to step SA70. If it is determined to be unsuccessful, the process proceeds to step SA140. At step SA60, CPU 101 determines that user authentication succeeded if information that authentication succeeded is received from authentication server 200 in connection with the user authentication requested at step SA50, and it determines that user authentication failed if information that authentication failed is received from authentication server 200.

At step SA50, by way of example, CPU 101 causes PM card 900 to output prescribed text data with digital signature using a secret key stored in PM card 900, and transmits the user name, the text data and the signature of PM card 900 to authentication server 200. If the signature decrypted by a public key corresponding to the user name matches the text data, authentication server 200 determines that user authentication succeeded, and if not, determines that user authentication failed.

At step SA140, CPU 101 displays an indication of log-in error on operation panel 106, and the log-in process ends.

On the other hand, at step SA70, CPU 101 permits log-in of the successfully authorized user and displays an operation image corresponding to the authority of the user. Then, the log-in process ends. Thus, the user can instruct MFP 100 to execute information processing in accordance with the authority of the user. The operation image in accordance with the user authority displayed at step SA70 reflects the function restrictions set for each user as described with reference to FIG. 4.

At step SA40, if communication with authentication server 200 is determined to be impossible, CPU 101 obtains the user name stored in PM card 900 at step SA80, and then the process proceeds to step SA90.

At step SA90, CPU 101 determines whether or not the user name obtained at step SA80 matches the user name stored as an administrator of MFP 100 in HDD 104 or the like. If the user names are determined to be matching, the process proceeds to step SA100, and if not, the process proceeds to step SA130.

At step SA130, CPU 101 displays an indication of log-in error on operation panel 106, and the log-in process ends.

At step SA100, CPU 101 displays an image requesting user ID and password for log-in as an administrator (for example, image 106A shown in FIG. 3) on operation panel 106, and waits for the input of user ID and password.

If these pieces of information are input, CPU 101 causes the process to proceed to step SA110.

At step SA110, CPU 101 determines whether or not the input ID and password match the ID and password stored as those for an administrator. If they are determined to be matching, the process proceeds to step SA120.

At step SA120, as at step S70 (see FIG. 5), CPU 101 displays an operation image for operating MFP 100 in the administrator mode on operation panel 106, and the log-in process ends.

In the embodiment described above, if MFP 100 can communicate with authentication server 200, MFP 100 executes a process to allow a user to log-in as an authorized user (steps SA50 to SA70). MFP 100 may be configured such that even if MFP 100 can communicate with authentication server 200, the user is allowed to log-in as an administrator through specific operations. By way of example, authentication server 200 may be adapted to also store the user ID and password for an administrator, and if the user ID and password input by the user match the user ID and password stored in authentication server 200, the user can log-in to MFP 100 as an administrator. Alternatively, an electronic certificate for an administrator may be stored in PKI card 900 separate from the electronic certificate for an authorized user, digital signature may be given to a specific piece of information using a secret key included in the electronic certificate, the specific piece of information and user ID may be transmitted to authentication server 200, and if user authentication of the user having the user ID succeeds at authentication server 200, the user can log-in to MFP 100 as an administrator.

In the present embodiment, as can be seen from steps SA50 to SA70, log-in as an authorized user requires user authentication by authentication server 200.

On the other hand, in the present embodiment, as can be seen from steps SA80 to SA120, log-in as an administrator is determined to be permitted/refused without using communication with authentication server 200.

In MFP 100, log-in of a user as an administrator is permitted/refused based on the PIN code in PM card 900 and on a determination as to whether data matching the user ID and password in HDD 104 has been input or not.

Therefore, a certain level of security can be ensured as input of a code in PM card 900 and input of information in MFP 100 are required, while log-in as an administrator is permitted even if MFP should fail to communicate with authentication server 200 because of some trouble, for example, on the network to which MFP 100 is connected.

Therefore, if communication with authentication server 200 should become impossible and user authentication by authentication server 200 becomes unavailable, and hence use of MFP by a user through normal log-in operation becomes impossible, MFP 100 can still permit log-in to the administrator mode.

Therefore, even if communication with authentication server 200 is impossible, MFP 100 can be operated at least in the public mode described above, to allow the user to use minimum functions without requiring log-in.

Further, even if communication with authentication server 200 is impossible, a separate server may be set as an authentication server 200 through operation contents setting in the administrator mode and, therefore, a process that requires communication with authentication server can be resumed promptly.

Since the log-in to the administrator mode is permitted not only by the checking of user ID and password for an administrator but also by checking the PIN code of PKI card for an administrator, security level at log-in as an administrator can be improved at the same time.

In the present embodiment, log-in of a user as an administrator may be permitted based on checking of PIN code and user authentication by authentication server 200. In that case also, log-in of a user as an administrator is permitted through two stages and, therefore, security level regarding the log-in of a user as an administrator can be improved.

### Third Embodiment

MFP 100 as a third embodiment of the information processing apparatus in accordance with the present invention may have hardware configuration similar to that of MFP 100 of the first embodiment.

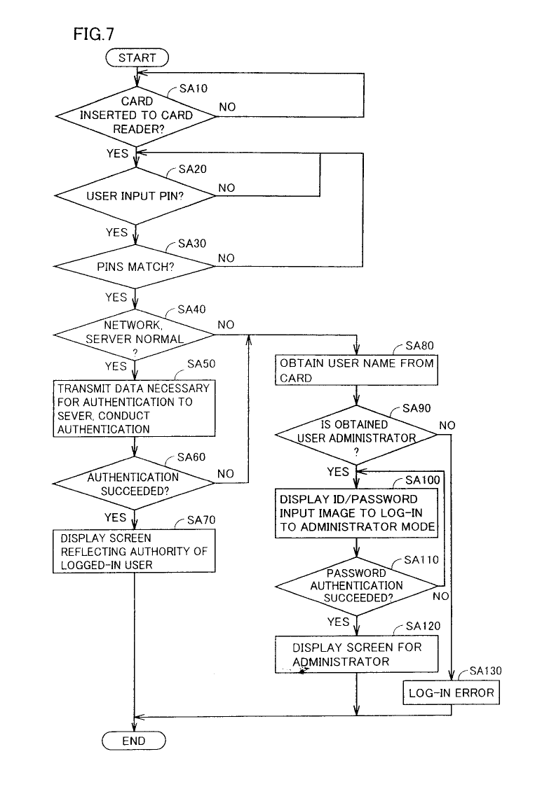

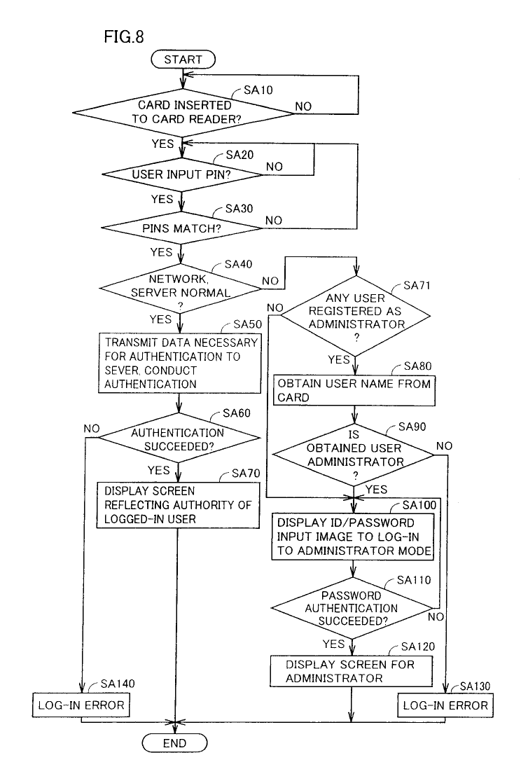

FIG. 7 is a flowchart representing a log-in process executed by CPU 101 in accordance with the present embodiment.

In the log-in process in accordance with the present embodiment, CPU 101 executes the process of steps SA10 to SA50 as in the log-in process of the second embodiment.

At step SA50, CPU 101 requests authentication server 200 to authorize the user, and the process proceeds to step SA60.

If CPU 101 determines that authentication has been successful at step SA60, the process proceeds to step SA70.

If it is determined that authentication failed at step SA60, different from the second embodiment in which the error display is given at step SA140, CPU 101 executes the process for determining whether or not log-in as an administrator is to be permitted/refused, following step SA80.

In the present embodiment described above, if MFP 100 can communicate with authentication server 200, CPU 101 once makes an inquiry to authentication server 200 as to whether the user can be authorized as a general user, based on the information stored in PM card 900.

If user authentication as a general user fails, it determines whether or not the user can log-in as an administrator.

Therefore, if a user having PM card 900 is not permitted to log-in as a general user but permitted to log-in as an administrator, MFP 100 can determine whether the user can log-in as an administrator.

As described above, since the log-in to the administrator mode requires not only checking of user ID and password for an administrator but also checking of the PIN code of PM card for an administrator, security level at log-in as an administrator can be improved at the same time.

### Fourth Embodiment

MFP 100 as a fourth embodiment of the information processing apparatus in accordance with the present invention may have hardware configuration similar to that of MFP 100 of the first embodiment.

FIG. 8 is a flowchart of the log-in process executed by CPU 101 in accordance with the present embodiment.

In MFP 100 in accordance with the present embodiment, HDD 104 stores, in addition to the user ID and password for an administrator, an ID (hereinafter referred to as “initial ID”) and a password (hereinafter referred to as “initial password”) to obtain permission of operation in the administrator mode at the time of initialization of MFP 100. The ID and password as such are used for operating MFP 100 in the administrator mode before user name and the like as an administrator permitted to log-in are registered with MFP 100.

Referring to FIG. 8, in the log-in process in accordance with the present embodiment, CPU 101 executes processes similar to those as described with reference to FIG. 6 at steps SA10 to SA40. Thereafter, if it is determined at step SA40 that communication with authentication server 200 is impossible, CPU 101 determines at step SA71 whether or not there is any user name registered as an administrator. If it is determined that a registered user name exists, the process proceeds to step SA80. A possible cause of communication failure with authentication server 200 is a failure in communication on the network.

At step SA71, if it is determined that no user name has been registered as an administrator, CPU 101 causes the process to proceed to step SA100.

At step SA100, CPU 101 displays an image requesting input of ID and password necessary to operate MFP 100 in the administrator mode on operation panel 106.

If it is determined that the ID and password have been input by the user, CPU 101 causes the process to proceed to step SA110.

At step SA110, CPU 101 determines whether the ID and password input at step SA100 match the ID and password stored for the administrator in HDD 104 or match the initial ID and initial password. If it is determined that the ID and password match either of these, the process proceeds to step SA120.

At step SA120, CPU 101 displays an image for operating MFP 100 in the administrator mode on operation panel 106, and the log-in process ends. Specifically, at step SA120, the process for allowing the operating user to operate MFP 100 in the administrator mode is executed.

In the embodiment described above, MFP 100 stores two combinations of ID and password for operation in the administrator mode. One combination is the ID and password for an administrator, and another combination is the ID and password (initial ID and initial password) for operating MFP 100 in the administrator mode before the ID and password for an administrator are stored. The initial ID and the initial password may be deleted from HDD 104 on condition that the ID and password for an administrator have been stored.

In MFP 100 of the present embodiment, before the ID and password for an administrator are stored in MFP 100 (NO at step SA71), the process for obtaining user name from PKI card 900 or the like at step SA80 and the like are omitted and the process proceeds to steps SA100.

As described above, since permission of log-in to the administrator mode requires not only the user ID and password for an administrator but also the PIN code of PKI card for an administrator, security level at log-in as an administrator can be improved at the same time.

[Other Modifications]

In the embodiments of the present invention, PKI card 900 is an example of a recording medium. The recording medium may be a medium that stores information contrasted with the information that is input to the input unit, including CD-ROM (Compact Disc-Read Only Memory), DVD-ROM (Digital Versatile Disk-Read Only Memory), USB (Universal Serial Bus) memory, memory card, FD (Flexible Disk), hard disk, magnetic tape, cassette tape, MO (Magnetic Optical Disc), MD (Mini Disk), IC (Integrated Circuit) card (except for memory card), optical card, mask ROM, EPROM and EEPROM (Electrically Erasable Programmable Read-Only Memory).

According to the embodiments of the present invention, an information processing apparatus can be operated in the administrator mode, if a piece of information matching a PIN code stored in a smart card communicable with the information processing apparatus is input and further, a piece of information matching a specific piece of information stored in the information processing apparatus is input.

Therefore, operation in the administrator mode requires input of information in two stages and, hence, security of log-in to the administrator mode can be improved.

Further, in the information processing apparatus, for the operation in the administrator mode, input of a piece of information matching not only the information stored in the information processing apparatus but also the information stored in the smart card is required.

Accordingly, fraudulent use of information required to be input for the administrator mode becomes more difficult and, hence, security of log-in to the administrator mode can be improved.

In each of the embodiments above, MFP 100 has been described as an example of the information processing apparatus. Information processing related to image forming operations including formation of image data and image output has been described as examples of executed information processing. The administrator mode in the information processing apparatus has been described as including settings of image forming operations such as scope of functions related to the image forming operations that can be realized user by user.

The information processing realized by the information processing apparatus in accordance with the present invention is not limited to such image forming operations. By way of example, the information processing apparatus may be a general-purpose computer, the information processing may include execution of various applications, and in the administrator mode, types of applications that can be realized user by user may be set.

The present invention is naturally applicable when it is realized by supplying a program to an image processing apparatus. The effects of the present invention can be enjoyed by supplying a recording medium (recording medium 800) storing the program represented by a software to attain the present invention to a system or an apparatus, with a computer (or a CPU or MPU (Micro-Processing Unit)) of the system or apparatus reading and executing the program code stored in the recording medium.

In that case, the program codes themselves read from the recording medium realize the functions of the embodiments described above, and the recording medium storing the program codes constitutes the present invention.

The functions of the embodiments described above may be realized by a computer executing the read program code, or the functions of the embodiments described above may be realized by a process, with an OS (operation system) running on a computer performing part of or all of the actual process.

Further, the program codes read from a recording medium may be written to a memory included in a functionality expansion board inserted to a computer or a functionality expansion unit connected to a computer, a CPU or the like provided on the functionality expansion board or the functionality expansion unit may perform part of or all of the actual process based on the instructions of the program codes, and by the actual process, the functions of the embodiments described above may be realized.

The recording medium may be a medium that stores a program or programs in a non-volatile manner, including CD-ROM, DVD-ROM, USB memory, memory card, FD hard disk, magnetic tape, cassette tape, MO (Magnetic Optical Disc), MD, IC card (except for memory card), optical card, mask ROM, EPROM and EEPROM.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An information processing apparatus, comprising:
an executing unit executing information processing;
a control unit controlling an operation of said executing unit;
a communication unit for communicating with a smart card;
an receiving unit for receiving input of information; and
a storage unit for storing specific information for executing an administrator mode; wherein
said control unit executes said administrator mode if information matching the PIN (personal identification number) code stored in said smart card and information matching the information stored in said storage unit are received by said receiving unit.

2. The information processing apparatus according to claim 1, wherein
said communication unit communicates with an authentication server;
said control unit authorizes the user of said smart card by communicating with said authentication server; and
said control unit executes said administrator mode, on condition that information matching the PIN code stored in said smart card is received by said receiving unit, when authentication of the user of said smart card is successful or when authentication of the user of said smart card and information matching said specific information stored in said storage unit is received by said receiving unit.

3. The information processing apparatus according to claim 2, wherein
said control unit determines whether or not said communication unit can communicate with said authentication server; and
if it is determined that said communication unit cannot communicate with said authentication server, authentication of the user of said smart card is determined to be failed.

4. The information processing apparatus according to claim 1, wherein
said storage unit stores a user name specified as an administrator; and
said receiving unit receives input of information on condition that a user name same as the user name stored in said storage unit is stored in said smart card.

5. The information processing apparatus according to claim 4, wherein
said storage unit stores said user name specified as an administrator, or a specific user name and a password associated with the specific user name;
said receiving unit receives said specific user name and said password on condition that the user name specified as an administrator is not stored in said storage unit; and
said control unit determines whether or not information matching said specific user name and said password is received by said receiving unit as said specific information for executing said administrator mode on condition that the user name specified as an administrator is not stored in said storage unit.

6. The information processing apparatus according to claim 1, wherein
said information processing executed by said executing unit includes image processing.

7. A method of controlling an information processing apparatus including a storage unit, an executing unit executing information processing and a control unit controlling an operation of said executing unit, comprising the steps of:
communicating with a smart card;
receiving input of a PIN (personal identification number) code;
determining whether or not the input PIN code matches the PIN code stored in said smart card;
storing specific information in said storage unit for executing an administrator mode;
receiving input of information corresponding to said specific information;
determining whether or not said input information corresponding to said specific information matches said specific information stored in said storage unit; and
causing said control unit to execute said administrator mode, if it is determined that the input PIN code matches the PIN code stored in said smart card and that the input information matches said specific information stored in said storage unit.

8. The method of controlling an information processing apparatus according to claim 7, further comprising the steps of
communicating with an authentication server; and
authorizing the user of said smart card by communicating with said authentication server; wherein
at said step of causing said control unit to execute said administrator mode, on condition that the input PIN code is determined to match said PIN code stored in said smart card, when authentication of the user of said smart card is successful or when authentication of the user of said smart card is unsuccessful and the input information is determined to match said specific information stored in said storage unit.

9. The method of controlling an information processing apparatus according to claim 8, further comprising the step of
determining whether or not communication with said authentication server is possible; wherein
at said step of authorizing the user of said smart card, if it is determined that said information processing apparatus cannot communicate with said authentication server, authentication of the user of said smart card is determined to be failed.

10. The method of controlling an information processing apparatus according to claim 7, wherein
the storage unit of said information processing apparatus stores a user name specifying an administrator; and
at said step of receiving input of said information, input of information is received on condition that a user name same as the user name specifying an administrator stored in said storage unit is stored in said smart card.

11. The method of controlling an information processing apparatus according to claim 10, wherein
said storage unit stores said user name specifying an administrator, or a specific user name and a password associated with the specific user name;
said method further comprising the steps of:
determining whether or not said user name specifying an administrator is stored in said storage unit; and
receiving input of said specific user name and said password, if said user name specifying an administrator is not stored in said storage unit; wherein
at said step of causing said control unit to execute said administrator mode, determination is made as to whether or not information matching said specific user name and said password is input as said information for executing said administrator mode.

12. A non-transitory recording medium recording a computer readable program for controlling a storage unit, an information processing apparatus including an executing unit executing information processing and a control unit controlling an operation of said executing unit, causing said information processing apparatus to execute the steps of
communicating with a smart card;
receiving input of a PIN (personal identification number) code;
determining whether or not the input PIN code matches the PIN code stored in said smart card;
storing specific information in said storage unit for executing an administrator mode;
receiving input of information corresponding to said specific information;
determining whether or not said input information corresponding to said specific information matches said specific information stored in said storage unit; and
causing said control unit to execute said administrator mode, if it is determined that the input PIN code matches the PIN code stored in said smart card and that the input information matches said specific information stored in said storage unit.

13. The recording medium according to claim 12, wherein
said program further causes said information processing apparatus to execute the steps of
communicating with an authentication server; and
authorizing the user of said smart card by communicating with said authentication server; wherein
at said step of causing said control unit to execute said administrator mode, on condition that the input PIN code is determined to match said PIN code stored in said smart card, when authentication of the user of said smart card is successful or when authentication of the user of said smart card is unsuccessful and the input information is determined to match said specific information stored in said storage unit.

14. The recording medium according to claim 13, wherein
said program further causes said information processing apparatus to execute the step of determining whether or not communication with said authentication server is possible; wherein
at said step of authorizing the user of said smart card, if it is determined that said information processing apparatus cannot communicate with said authentication server, authentication of the user of said smart card is determined to be failed.

15. The recording medium according to claim 12, wherein
the storage unit of said information processing apparatus stores a user name specifying an administrator; and
at said step of receiving input of said information, input of information is received on condition that a user name same as the user name specifying an administrator stored in said storage unit is stored in said smart card.

16. The recording medium according to claim 15, wherein
said storage unit stores said user name specifying an administrator, or a specific user name and a password associated with the specific user name;
said program further causes said information processing apparatus to execute the steps of:
determining whether or not said user name specifying an administrator is stored in said storage unit; and
receiving input of said specific user name and said password, if said user name specifying an administrator is not stored in said storage unit; wherein
at said step of causing said control unit to execute said administrator mode, determination is made as to whether or not information matching said specific user name and said password is input as said information for executing said administrator mode.
